(19) United States
(12) Patent Application Publication
(10) Pub. No.: US 2006/0067260 A1
(43) Pub. Date: Mar. 30, 2006

(54) Updating associating data in a media device

(76) Inventors: Timo Tokkonen, Oulu (FI); Helena Tokkonen, Oulu (FI); Juha P. Matero, Oulu (FI)

Correspondence Address: Hollingsworth & Funk, LLC;Suite 125, 8009 34th Avenue South, Minneapolis, MN, 55425, US

(21) Appl. No.: 10/955,652

(22) Filed: Sep. 30, 2004

(51) Int. Cl. H04B 7/00

(52) U.S. Cl. 370/310

(57) ABSTRACT

A method of updating associating data in a media device is provided. The associating data relates to a service being transmitted over a radio interface of a telecommunication system and associates the service with a broadcast media stream transmitted by a broadcast system. A media device receives a broadcast media stream from a broadcast system. The geographical location of the media device is determined. The media device sends a query for associating data, the query comprising information about the geographical location of the media device. The query is received and associating data is determined for more than one broadcast media stream transmitted to the geographical area in the vicinity of the media device and sent to the media device. The media device receives and stores the associating data.

### FIELD

The invention relates to updating associating data in a media device. Especially the invention relates to media devices configured to receive a broadcast media stream from a broadcast system.

### BACKGROUND

Broadcasters, such as television and radio broadcasters, have taken steps forward to provide an audience with digital supplementary services, such as program information, news, weather information, competitions and other related content, in addition to a traditional media stream. The digital supplementary services are usually delivered to the audience over the Internet using the audiences' personal computers or other media devices capable of connecting to the Internet.

More mobility is provided for the audience by media devices of cellular telecommunication systems, which media devices are equipped with a receiver, such as an FM radio, for receiving media streams broadcast by broadcasters. Broadcasters typically provide Internet services, which can be accessed by media devices, such as the one equipped with a WAP (Wireless Application Protocol), capable of connecting to such a service. In order to obtain the service needed, the user is required to navigate to the broadcaster's Internet site, select the right service and download suitable data which enables the user's media device to receive the service. In order to inform the users about services available, the broadcasters usually promote their Internet address in actual television or radio broadcasts, or in other mass media.

There are, however, problems related to complexity in accessing a service by a user. The complexity arises from a need for advertising service addresses by the broadcasters and memorizing desired service addresses by the user. Furthermore, navigating a way through a complicated Internet web structure to the correct service address is laborious and time consuming. The complexity in accessing the service results in a high barrier for a user to connect to a service and low ratings of the service.

### BRIEF DESCRIPTION OF THE INVENTION

An object of the invention is to provide an improved solution for accessing a supplementary service associated with a broadcast stream. According to an aspect of the invention, there is provided a method of updating associating data in a media device, the associating data relating to a service being transmitted over a radio interface of a cellular telecommunication system and associating the service with a broadcast media stream transmitted by a broadcast system, the method comprising: receiving a broadcast media stream from a broadcast system by the media device; determining the geographical location of the media device; sending a query for associating data by the media device, the query comprising information about the geographical location of the media device; receiving the query and determining associating data for more than one broadcast media stream transmitted to the geographical area in the vicinity of the media device and sending the associating data to the media device; receiving and storing the associating data by the media device.

According to another aspect of the invention, there is provided a media device configured to: communicate with a cellular telecommunication system; receive a broadcast media stream from a broadcast system by the media device; send a query to the cellular telecommunication system for associating data relating to the broadcast media stream, the query comprising information about the geographical location of the media device; and receive the associating data from the cellular telecommunication system and store the received associating data.

According to yet another aspect of the invention, there is provided a computer program distribution medium readable by a computer and encoding a computer program of instructions for executing a computer process for updating associating data in a media device, the process comprising: communicating with a cellular telecommunication system; receiving a broadcast media stream from a broadcast system by the media device; sending a query to the cellular telecommunication system for associating data relating to the broadcast media stream, the query comprising information about the geographical location of the media device; receiving the associating data from the cellular telecommunication system and storing the received associating data.

The invention provides several advantages. In an embodiment, the invention provides easy downloading of associating data which enables a user to receive all supplementary services associated with broadcast media streams available in the vicinity of the media device. Thus, when the user tunes to a new media stream, he/she is not required to query the associating data for each stream separately. Instead, such a query needs to be performed only once, because when the query is performed, associating data relating to all media streams available in the area is downloaded to the media device at the same time and stored in the media device.

In an embodiment, the invention makes the downloading of associating data of a single broadcast stream easier by removing the need of navigating a way through a complicated Internet web structure. The process of querying the associating data is more automatic and user friendly.

### LIST OF DRAWINGS

In the following, the invention will be described in greater detail with reference to the embodiments and the accompanying drawings, in which

FIG. 1 illustrates an example of a system in which embodiments of the invention may be utilized;

FIG. 2 illustrates an example of a media device,

FIG. 3 illustrates another example of a system in which embodiments of the invention may be utilized; and

FIG. 4 illustrates an embodiment with a flow chart.

### DESCRIPTION OF EMBODIMENTS

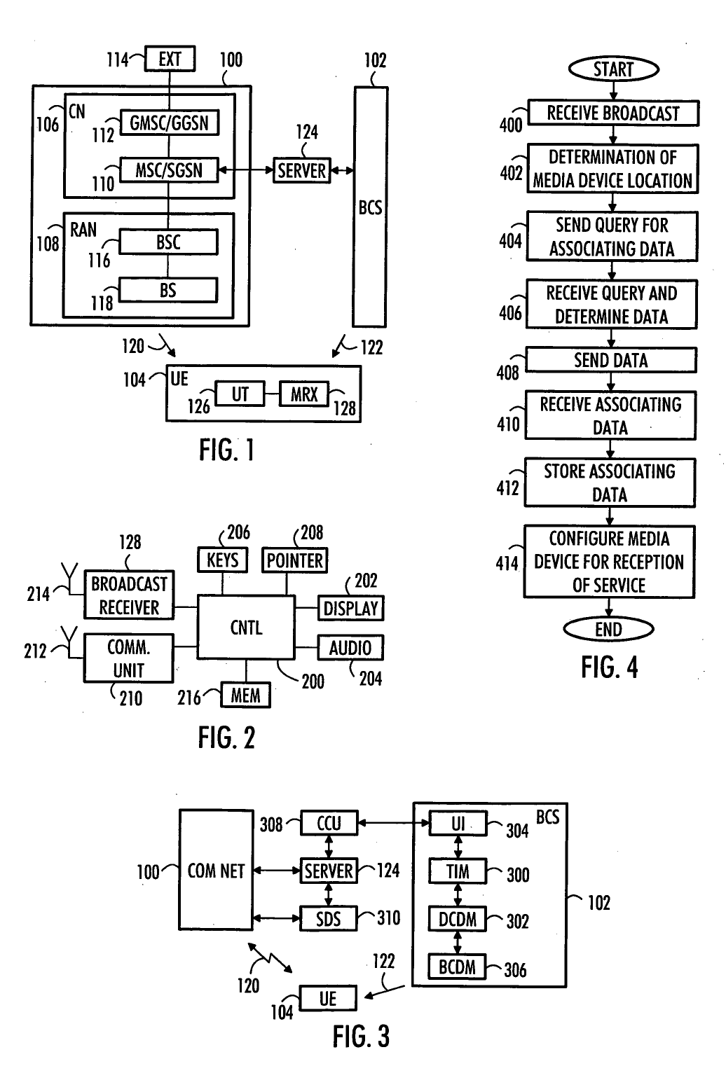

FIG. 1 illustrates an example of a simplified structure of a system in which embodiments of the invention may be utilized. The system comprises a communication network 100 of a cellular telecommunications system, a broadcast system 102, and a media device 104 of the cellular telecommunications system.

The cellular telecommunications system is based on, for example, a GSM (Global System for Mobile Communications) or UMTS (Universal Mobile Telecommunications System). The radio interface used in the communication between the communication network and the media device may be realised using WCDMA (Wideband Code Division Multiple Access) technology, GPRS (General Packet Radio Service) or WLAN (Wireless Local Area Network), or any other similar services offering solution. The structure and functions of cellular telecommunications systems are known to a person skilled in the art, and not all network elements of the system are illustrated.

The communication network 100 provides the media device 104 with bi-directional communication services. The broadcast system 102 provides the media device 104 with a media stream 122 using, for example, a radio or television broadcast.

The communication network 110 may represent the fixed infrastructure of the cellular telecommunication system. The communication network 110 may comprise a core network (CN) 106 representing a radio-independent layer of the communication network 110, and at least one radio access network (RAN) 108. The core network 106 may include network elements of different generations of cellular telecommunications systems. The radio access network 108 provides the media device 104 with radio interface using a radio access technology. The media device thus has a bi-directional radio connection 120 with the radio access network 108.

In the example shown in FIG. 1, the core network 106 is exemplified in terms of GSM terminology using both circuit-switched and packet-switched network elements. The packet-switched network elements are described in terms of a GPRS (General Packet Radio Service) system, which provides the media device 104 with access to external data networks over GSM and supports standard protocols, such as TCP (Transmission Control Protocol) and IP (Internet Protocol). The invention is not, however, restricted to the systems, division of systems, or protocols used in the system described in the examples, but can be applied to any cellular telecommunications system.

A center 110 represents a mobile services switching center (MSC) and a serving GPRS support node (SGSN) enabling circuit-switched and packet-switched signaling, respectively, in the cellular telecommunications system.

A function of the serving GPRS support node 110 is to transmit packets to and receive them from the media device 104 supporting packet-switched transmission. The serving GPRS support node 110 includes subscriber information and location information about the media device 104.

The core network 106 may also have a gateway unit 112 representing both a gateway mobile service switching center (GMSC) and a gateway GPRS support node (GGSN). The GMSC attends to the circuit-switched connections between the core network 106 and external networks (EXT) 114, such as a public land mobile network (PLMN) or a public switched telephone network (PSTN), and the GGSN attends to the packet-switched connections between the core network 106 and external networks 114, such as the Internet.

The center 100 controls the radio access network 108, which may comprise at least one base station controller (BSC) 116 controlling at least one base station (BS) 118. The base station controller 116 may also be called a radio network controller, and the base station 118 may be called a node B.

The system of FIG. 1 further comprises a server 124 connected to the communication network 100 and the broadcast system 102 for providing the media device 104 with a service associated with the media stream 122 by using the radio interface of the cellular telecommunication system. The server 124 may be a computer, such as a personal computer or a workstation with an interface to the communication network 100 and the broadcast system 102. The physical location of the server 124 is not relevant as far as required connections exist.

The server 124 may be connected to the center 110, the gateway unit 112, the radio access network 106, or other parts of the communication network 100. The server 124 may be connected to the communication network 100 via an external network 114. In an embodiment, the server 124 communicates with the communication network 100 over the radio interface of the cellular telecommunication system.

The media device 104 comprises a user terminal 126 for communicating in the cellular telecommunication system using a radio interface provided by the base station 118. The media device 104 further comprises a media receiver 128, such as an FM receiver or a television receiver, for receiving a media stream 122 provided by the broadcast system 102.

The base station 118 may communicate with the media device 104 using GPRS, in which data is transferred in packets that contain address and control data in addition to the actual content data. Several connections may employ the same transmission channel simultaneously. This kind of packet switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and the use of the communication network 100.

The server 124, for example, controls the content flow between the media device 104 and the communication network 100. The server 124 may also facilitate timed delivery of content of the service to the media device 104.

The media stream 122 is broadcasted by the broadcast system 102. The media stream 122 may include, for example, a radio or television program, a commercial or an announcement. The media stream 122 may include speech, music, or pictures. The content of the media stream 122, however, is not relevant to the present solution. The media device is configured to receive the broadcasted media stream 122 with the media receiver 128.

The media device may be provided with a service which is associated and/or synchronized with the broadcasted media stream 122 transmitted by the broadcast system. The service may provide thee user of the media device with visual information related to the content of the broadcast media stream 122. The service may be interactive. The service may include information about the music played at the moment, a timetable of the program, DJ's messages to the listeners or the like. The signal may include any of these features alone or as a combination thereof. The service may include information about deliverable or purchasable objects related to the media stream, such as ring tones, desktop wallpapers or logos.

The service may be provided to the media device 104 utilizing a communication channel parallel to the broadcast channel used in delivering the media stream 122 to the user. This is called a parallel channel operation. A logical address may be dedicated to the service 120 so that the service 120 may be accessed by using the logical address of a database 130 of the server 112. The database 130 of the service comprises computer files containing the service content. The content of the service may vary as a function of time and possibly as a function of the content of the media stream 122. The service 120 provides a bit stream to the user equipment 110, the bit stream including information content, such as graphical information, text information, audio information, a computer program, Braille, vibration, or any combination thereof. In an embodiment, the content of the service 120 is displayed on a display of the user equipment 110.

When the parallel channel software operation in the media device 104 is initiated, the media device 110 may subscribe to the service by transmitting information about itself to the server 124. After receiving the subscription, the server 124 starts transmitting the service to the media device 104. With the information about the media device 104, a specific variant of the content of the service can be delivered, which contains graphics objects optimized to the capabilities and the screen size of each media device 104.

A service provider is a party possessing rights for relevant digital content of the service 120, a distribution system for providing the media device 104 with the service 120, and possibly the capability to bill the user for the service 120. The service provider's delivery system is responsible for receiving and handling delivery requests and delivering the service 120 to the media device 104.

In the media device 104, the solution provides an integrated user experience, allowing the user to start both listening to a media stream 122 and receiving the content of the service relating to the media stream 122. The operation of the media is based on two channels, the broadcast channel and the parallel channel enabled by the cellular telecommunication system.

In an embodiment, the service concept may be called a visual radio. The broadcast system broadcasts a radio transmission 122 received by the media device 104. The DJ or announcer of the radio transmission may advertise the service realized with the parallel channel. The user of the media device may subscribe to the service by making contact with the server and downloading suitable data which enables the user's media device to receive the service. The data may be called associating data and it may comprise information which provides a linkage between the service and the media stream and which identifies the service transmission.

The associating data may include the following type of information: a radio service address, a service identification, an object identification, a radio broadcaster identification number, a program identification number, a traffic announcement identification number, a traffic program identification number, a program item number, an emergency warning message, a music/speech indicator, a radio frequency utilized by a media stream, a program service name, a program type identification number, and a country code.

Typically but not necessarily, a service is associated with a given media stream. Each media stream may have a distinct service associated and/or synchronized with it. In solutions of prior art, a user has to download associating data for each media stream separately. In a given area there may be several media broadcasters which broadcast their own media stream. For example, transmissions of several radio stations may be received in the same area. Several radio stations may provide their users with a service realized with a parallel channel.

With reference to FIG. 2, examine an example of a media device in which embodiments of the invention can be applied. The media device comprises controlling means 200, typically implemented with a microprocessor, a signal processor or separate components and associated software. The device further comprises a display 202. The display is typically configured to display graphics and text. The device may also comprise an audio interface 204, which may be realized with a speaker or headset and a microphone, for example. The device may further comprise a keypad 206 and a pointer device 208, such as a mouse, a track stick or a touch-pad. Depending on the type of the device, there may be different and a different number of user interface parts.

The media device also comprises a communication unit 210 implementing the functions of terminal equipment including speech and channel coders, modulators and RF parts. The device may also comprise an antenna 212 connected to the communication unit. The device may also comprise a broadcast receiver 128 configured to receive broadcast transmissions sent by a broadcast system. The receiver 128 is a radio or television receiver, for example. The device may also comprise an antenna 214 connected to the broadcast receiver 128. The device may also comprise a single antenna connected to both the communication unit 210 and the broadcast receiver 128. The device also typically comprises a memory 216 for storing e.g. telephone numbers, communication parameters, broadcast receiver parameters, calendar data and other user-specific data.

The media device is not restricted to the above example. The media device may be a personal computer, a personal digital assistant, terminal equipment or any other device comprising required communication facilities.

With reference to FIG. 3, study an example of the structure of a system in which embodiments of the invention may be utilized. The system comprises a communication network 100 of a cellular telecommunications system, a broadcast system 102, a media device 104 and a server 124. The broadcast system 102 provides the media device 104 with a media stream 122 using, for example, a radio or television broadcast. The server provides the media device with a service associated with the broadcast stream on a parallel channel using the telecommunication system.

The broadcast system may comprise a timing information module 300, a dynamic content delivery module 302, a user interface 304 and a broadcast content delivery module 306.

Timing information on the broadcast to synchronize transmissions of the broadcast channel and the parallel channel is communicated to the server 124 by the timing information module 300. The timing information module 300 provides information on the starting time and the ending time of a particular program, as well as information on the timing of advertising breaks, starting and ending of a song, for example.

The dynamic content delivery module 302 can provide additional content information to the service provided by the server 124. The additional content information from the dynamic content delivery module 302 can be for example results of events in the broadcast, such as the name of a winner in a quiz show, when the additional content information is determined during the program, for example in live events, sports coverage or in broadcast radio.

In addition, the dynamic content delivery engine module 302 can receive interaction results from the server 124 used as part of the broadcast, for example, to display the results of a vote.

The broadcasting personnel use a user interface 304 to control and adjust parallel channel timing of the content items with respect to the broadcast media stream. For example, the signaling in the parallel channel may be paused and resumed.

A broadcast content delivery module 306 transmits the broadcast to the media device 104.

The server 124 provides the media device with broadcast-related service based on parallel channel. In an embodiment, the system comprises a content creation unit (CCU) 308 connected to the server 124 and the broadcast system 12 for providing content for the service. The content creation unit 308, which can also be called a visual radio tool in some applications, may be used to create service content presentation to be displayed on the media device 104. The content creation unit 308 may be located and integrated into the broadcast system 102, or into the server 124.

The content creation unit 308 may allow a broadcast system to create a visual presentation and manage the content flow shown on the screen of the media device 104 in synchronization with the media stream 122.

The content creation unit 308 may also define timing to display the content of the service in the media device 104 in relation to broadcast media stream timeline.

In an embodiment, the system further comprises a station directory service 310 for providing the media device 104 with associating data for associating the media stream 122 with the service. The station directory service 310 may be a register located in the server 124, the communication network 100, or the broadcast system 102 or a separate server connected to the communication network 100.

FIG. 4 illustrates an embodiment with a flow chart. In phase 400, the media device 104 is receiving a broadcast media stream 122 transmitted by the broadcast content delivery module 306 of the broadcast system 102. The media receiver is thus tuned to the frequency of the broadcast transmission.

In phase 402, the geographical location of the media device is determined. In an embodiment, the location is determined in the media device 104. The media device may comprise a satellite position receiver, such as a GPS receiver. The media device may also determine the location from the base station identification sent by the base station 118 of the telecommunication system 100 the device is connected to. In an embodiment, the needed accuracy of the location determination is the locality the device is in. In an embodiment, the location is determined in the telecommunication system 100 and signaled to the media device by the base station 118.

In phase 404, the user of the media device wishes to receive additional service associated and synchronized with the broadcast media stream the media device 104 is receiving. The media device 104 sends a query to the telecommunication system for associating data of the desired service. The query comprises information about the geographical location of the media device. The sending of the query may be realized in several ways. In an embodiment, the user navigates to a predetermined web site using the web browser of the media device. The user may select the correct geographical location and select the desired media stream from a list of stream provided in the web site. In an embodiment, the users send a query message to a given address. The query message may comprise information about the location about the media device and also information about the media stream.

In phase 406, the query is received. In an embodiment, the system comprises a station directory service 310 which is configured to receive and process queries relating to the services associated with media streams. For example, the station directory service 310 may maintain the above described web page service. The station directory service 310 receives the query comprising information about the location of the media device and determines associating data for more than one service associated with media streams available in the area where the media device is located. In an embodiment, associating data for all services associated with media streams available in the area is determined.

In phase 408, the determined associating data is sent to the media device 104 using the air interface of the telecommunication system. In an embodiment, the data is sent by the station directory service 310.

In phase 410, the media device 104 receives the associating data.

In phase 412, the media device 104 stores the associating data.

In phase 414, the media device is configured by using the associating data for reception of a service associated with the broadcast media stream the media device is currently receiving.

In an embodiment, the associating data for service of each broadcast stream is stored in the same programmable program memory location as the information related to the broadcast media stream. Thus, when the user switches to another channel by selecting a programmable memory location, the device is able to start receiving the associated service at the same time.

The received associating data may also comprise data of services associated with broadband media streams which are not stored in programmable program memory locations. In an embodiment, this kind of associating data is stored in memory of the media device 104 for future use. For example, the user may manually tune to a broadband media stream which has not been stored in a programmable program memory location, and start receiving the media stream. The media device may load the associating data from the memory of the media device, the data relating to a service being associated to the broadcast media stream the media device started receiving. The media device may be configured by using the associating data to receive a service associated with the broadcast media stream.

In an embodiment, the media device 104 sends a query to the telecommunication system for associating data of the desired service. The query comprises information about the geographical location of the media device and also information about a frequency a broadcast media stream is transmitted on. The query is received by a station directory service 310 which is configured to receive and process queries relating to the services associated with media streams. The station directory service 310 determines a media stream on the basis of the location data and the frequency specified in the query. The media stream is transmitted on the specified frequency in the area surrounding the specified location. The station directory service 310 determines associating data for the service associated with the media stream. Next, the determined associating data is sent to the media device 104 using air interface of the telecommunication system.

Even though the invention is described above with reference to an example according to the accompanying drawings, it is clear that the invention is not restricted thereto but it can be modified in several ways within the scope of the appended claims.

1. A method of updating associating data in a media device, the associating data relating to a service being transmitted over a radio interface of a cellular telecommunication system and associating the service with a broadcast media stream transmitted by a broadcast system, the method comprising:
receiving a broadcast media stream from a broadcast system by the media device;
determining the geographical location of the media device;
sending a query for associating data by the media device, the query comprising information about the geographical location of the media device;
receiving the query and determining associating data for more than one broadcast media stream transmitted to the geographical area in the vicinity of the media device and sending the associating data to the media device;
receiving and storing the associating data by the media device.

2. The method of claim 1, further comprising:
configuring the media device for reception of the service associated with the media stream by using the associating data.

3. The method of claim 1, further comprising:
configuring the media device by using the associating data for reception of a service associated with the broadcast media stream the media device is currently receiving.

4. The method of claim 3, further comprising:
storing the associating data and the information related to the broadcast media stream in the same program memory location.

5. The method of claim 1, further comprising:
storing the associating data relating to a service being transmitted over a radio interface of a cellular telecommunication system, the service being associated with a broadcast media stream available in the vicinity of the media device but not currently received by the media device in a memory of the media device.

6. The method of claim 1 further comprising:
switching to receive another broadcast media stream;
loading the associating data from the memory of the media device, the data relating to a service being transmitted over a radio interface of a cellular telecommunication system, the service being associated with the broadcast media stream,
configuring the media device by using the associating data for receiving a service associated with the broadcast media stream the media device is receiving.

7. The method of claim 1, the associating data including at least one of the following:
a service identification
a radio service address
a radio broadcaster identification number
a program identification number
a traffic announcement identification number
a traffic program identification number
a program item number
an emergency warning message
a music/speech indicator
a radio frequency utilized by a media stream
a program service name
a program type identification number
a country code.

8. The method of claim 1, further comprising:
sending a reception query by the media device over the radio interface to a server connected to the cellular telecommunication system, the query comprising a request to receive a service associated with a broadcast media stream; and
receiving and responding to the query by the server.

9. The method of claim 1, wherein the service associated with a broadcast media stream comprises a communication channel synchronized with the broadcast media stream.

10. The method of claim 1, the service associated with a broadcast media stream providing visual and interactive bidirectional communication channel synchronized with the broadcast media stream.

11. A method of updating associating data in a media device, the associating data relating to a service being transmitted over a radio interface of a cellular telecommunication system and associating the service with a broadcast media stream transmitted by a broadcast system on given frequencies, the method comprising:
receiving a broadcast media stream from a broadcast system by the media device;
determining the geographical location of the media device;
sending a query for associating data by the media device, the query comprising information about the geographical location of the media device and a frequency a broadcast media stream is transmitted on;
receiving the query and determining associating data for the broadcast media stream transmitted on the given frequency to the geographical area in the vicinity of the media device and sending the associating data to the media device;
receiving and storing the associating data by the media device.

12. A media device configured to:
communicate with a cellular telecommunication system;
receive a broadcast media stream from a broadcast system by the media device;
send a query to the cellular telecommunication system for associating data relating to the broadcast media stream, the query comprising information about the geographical location of the media device; and
receive the associating data from the cellular telecommunication system and store the received associating data.

13. The media device of claim 12, comprising means for configuring the media device for reception of a service associated with the broadcast media stream by using the associating data.

14. The media device of claim 12, comprising means for determining the geographical location of the media device.

15. The media device of claim 12, configured to query the radio cellular network for information about the location of the media device.

16. A media device configured to:
communicate with a cellular telecommunication system;
receive a broadcast media stream on a given frequency from a broadcast system by the media device;
send a query to the cellular telecommunication system for associating data relating to the broadcast media stream, the query comprising information about the geographical location of the media device and a frequency a broadcast media stream is transmitted on; and
receive the associating data from the cellular telecommunication system and store the received associating data.

17. An arrangement for updating associating data in a media device, the arrangement comprising a server connected to a cellular telecommunication system and to a broadcast system, the server being configured to transmit at least one service over a radio interface of the cellular telecommunication system, the service being associated with a broadcast media stream transmitted by the broadcast system;
store associating data for associating services with broadcast media streams;
receive a query from a media device for associating data, the query comprising information about the geographical location of the media device, determining associating data for more than one broadcast media stream transmitted to the geographical area in the vicinity of the media device; and
sending the associating data to the media device.

18. The arrangement of claim 17, wherein the server is further configured to receive a reception query from a media device, the query comprising a request to receive a service associated with a broadcast media stream received by the media device.

19. The arrangement of claim 17, wherein the server is further configured to receive a reception query from a media device, the query comprising a request to receive a service associated with a broadcast media stream received by the media device.

20. An arrangement for updating associating data in a media device, the arrangement comprising a server connected to a cellular telecommunication system and to a broadcast system, the server being configured to
transmit at least one service over a radio interface of the cellular telecommunication system, the service being associated with a broadcast media stream transmitted by the broadcast system;
store associating data for associating services with broadcast media streams;
receive a query from a media device for associating data, the query comprising information about the geographical location of the media device and a frequency a broadcast media stream is transmitted on,
determining associating data for more than one broadcast media stream transmitted to the geographical area in the vicinity of the media device; and
sending the associating data to the media device.

21. A computer program product encoding a computer program of instructions for executing a computer process for updating associating data in a media device, the process comprising:
communicating with a cellular telecommunication system;
receiving a broadcast media stream from a broadcast system by the media device;
sending a query to the cellular telecommunication system for associating data relating to the broadcast media stream, the query comprising information about the geographical location of the media device;
receiving the associating data from the cellular telecommunication system and storing the received associating data.

22. A computer program distribution medium readable by a computer and encoding a computer program of instructions for executing a computer process for updating associating data in a media device, the process comprising:
communicating with a cellular telecommunication system;
receiving a broadcast media stream from a broadcast system by the media device;
sending a query to the cellular telecommunication system for associating data relating to the broadcast media stream, the query comprising information about the geographical location of the media device;
receiving the associating data from the cellular telecommunication system and storing the received associating data.

23. The computer program distribution medium of claim 22, the distribution medium comprising a computer readable medium, a program storage medium, a record medium, a computer readable memory, a computer readable software distribution package, a computer readable signal, a computer readable telecommunications signal, and a computer readable compressed software package.

24. A computer program distribution medium readable by a computer and encoding a computer program of instructions for executing a computer process for updating associating data in a media device the process comprising:
communicating with a cellular telecommunication system;
receiving a broadcast media stream from a broadcast system by the media device;
sending a query to the cellular telecommunication system for associating data relating to the broadcast media stream, the query comprising information about the geographical location of the media device and a frequency a broadcast media stream is transmitted on;
receiving the associating data from the cellular telecommunication system and storing the received associating data.
